(19) United States
(12) Patent Application Publication
(10) Pub. No.: US 2021/0170310 A1
(43) Pub. Date: Jun. 10, 2021

(54) Filter Assembly Employing Cloth Filter Layer for Use in Self-Cleaning Filter

(71) Applicant: FILTER ART LTD., Metula (IL)

(72) Inventor: Amihai Kotler, Metula (IL)

(21) Appl. No.: 16/704,053

(22) Filed: Dec. 5, 2019

(51) Int. Cl. B01D 29/05; B01D 29/68; B01D 39/08; B01D 29/13; B01D 29/58

(52) U.S. Cl. CPC B01D 29/055; B01D 29/688; B01D 39/083; B01D 29/13; B01D 29/58; B01D 2239/0613; B01D 2201/082; B01D 2201/202; B01D 2239/0654; B01D 2239/0618; B01D 2201/0407

(57) ABSTRACT

A filter filters a flow of liquid and has a pressure vessel, a filter assembly deployed within the pressure vessel, and a backwash assembly. The pressure vessel has an inlet, an outlet, and a flow path in fluid communication with the outlet. The filter assembly has at least one filter unit and at least one support configuration that supports the at least one filter element. The at least one filter element has first and second coarse mesh material support layer that have apertures of a first and second size, respectively, and a cloth filter layer that has apertures of a third size smaller than the first and second sizes. The cloth filter layer is interposed between the first and second coarse mesh material support layers. The backwash assembly has a suction nozzle in facing relation to a first or second surface of the filter unit.

### TECHNICAL FIELD

The present invention relates to filters for filtering liquid.

### BACKGROUND OF THE INVENTION

It is known to provide in-line filtering of liquids, such as water, to remove particles down to a desired size. Common configurations for such filters include employing double-sided filter disks or cylindrical filter screens formed from multiple layers deployed within a pressure vessel through which the liquid flows. Such filter configurations include a fine mesh layer, typically made from metal, that provides the primary filtering functionality. However, such multi-layer filter configurations are typically high-cost, due in part to the implementation of the filter layer as a layer of fine metal mesh.

### SUMMARY OF THE INVENTION

The present invention is a filter, and corresponding and associated components, for filtering a flow of liquid. The filter operates in a pressurized environment and includes one or more filter elements and a backwash arrangement for performing “self-cleaning” of the filter element(s) in order to allow continuous (or near continuous) operation of the filter. The filter element(s) utilize a cloth filter layer, constructed from woven or non-woven fabric conventionally used in disposable filtering applications, in place of the fine metal mesh typically employed in prior art solutions. Employment of cloth filter layers in place of fine metal mesh achieves comparable, and in some cases superior, filtering results at a small fraction of the implementation cost. Such cloth filter layers are difficult to clean when used in non-pressurized cleaning system. Therefore, the use of cloth filter layers in pressurized cleaning systems is an advantageous aspect of the present invention. However, such cloth filter layers are more delicate and less robust than fine metal mesh, particularly when employed in pressurized systems in which forward and reverse pressure differentials may damage the cloth filter layer. Accordingly, in order to withstand such pressure differentials during the cleaning prosses, the cloth filter layer, according to embodiments of the present invention, is supported on both sides by one or more coarse mesh material (preferably metal) layers.

According to the teachings of an embodiment of the present invention, there is provided a filter for filtering a flow of liquid. The filter comprises: a pressure vessel having an inlet, an outlet, and a flow path in fluid communication with the outlet; a filter assembly deployed within the pressure vessel, the filter assembly including at least one filter unit including at least one filter element and a filter element support member having at least one support configuration that supports the at least one filter element, the at least one filter element includes: at least one first coarse mesh material support layer having two faces and including apertures of a first size, at least one second coarse mesh material support layer having two faces and including apertures of a second size, and at least one cloth filter layer having two faces and including apertures of a third size smaller than the first and second sizes, the at least one cloth filter layer is interposed between the at least one first and second coarse mesh material support layers such that one of the faces of the at least one first coarse mesh material support layer bears against one of the two faces of the at least one cloth filter layer, and such that one of the faces of the at least one second coarse mesh material support layer bears against an other one of the two faces of the at least one cloth filter layer, and unfiltered liquid flows through the at least one filter unit between a first surface of the at least one filter unit, formed by one of faces of the first or second coarse mesh material support layer, and a second surface of the at least one filter unit, formed by one of faces of the second or first coarse mesh material support layer, and the at least one filter unit has an outlet for flow of filtered liquid to the flow path; and a backwash assembly including at least one suction nozzle deployed in facing relation to at least one of the first or second surfaces of the at least one filter unit.

Optionally, the third size is in a range between 0.5 microns and 30 microns.

Optionally, the first and second sizes are in a range between 50 microns and 600 microns.

Optionally, the at least one first coarse mesh material support layer is deployed to cover substantially the entirety of the one of the two faces of the at least one cloth filter layer, and the at least one second coarse mesh material support layer is deployed to cover substantially the entirety of the other one of the two faces of the at least one cloth filter layer.

Optionally, the at least one first coarse mesh material support layer includes a first plurality of coarse mesh material support layers, and the at least one second coarse mesh material support layer includes a second plurality of coarse mesh material support layers.

Optionally, the first plurality of coarse mesh material support layers includes an innermost coarse mesh material support layer and an outermost coarse mesh material support layer, and the innermost coarse mesh material support layer is a closest layer of the first plurality of coarse mesh material support layers to the one of the two faces of the at least one cloth filter layer, and the outermost coarse mesh material support layer is a farthest layer of the first plurality of coarse mesh material support layers from the one of the two faces of the at least one cloth filter layer, and the second plurality of coarse mesh material support layers includes an innermost coarse mesh material support layer and an outermost coarse mesh material support layer, and the innermost coarse mesh material support layer of the second plurality of coarse mesh material support layers is a closest layer of the second plurality of coarse mesh material support layers to the other one of the two faces of the at least one cloth filter layer, and the outermost coarse mesh material support layer of the second plurality of coarse mesh material support layers is a farthest layer of the second plurality of coarse mesh material support layers from the other one of the two faces of the at least one cloth filter layer.

Optionally, each coarse mesh material support layer of the first and second pluralities of coarse mesh material support layers has apertures of a size larger than the third size.

Optionally, the at least one first coarse mesh material support layer includes exactly one coarse mesh material support layer, and the at least one second coarse mesh material support layer includes exactly one coarse mesh material support layer.

Optionally, the filter further comprises: at least one coarse mesh material spacer layer interposed between the at least one cloth filter layer and one of the coarse mesh material support layers.

Optionally, the at least one first and second coarse mesh material support layers are formed from metal mesh.

Optionally, the at least one cloth filter layer is formed from a non-woven fabric.

Optionally, the non-woven fabric is made from polymer fibers.

Optionally, the polymer fibers include polypropylene or polyester.

Optionally, the at least one cloth filter layer is formed from a woven fabric.

Optionally, the at least one filter unit forms a disk filter structure.

Optionally, the at least one filter unit forms a cylindrical filter structure.

Optionally, the first and second sizes are equal.

There is also provided according to an embodiment of the teachings of the present invention a filter unit for filtering a flow of liquid, the filter unit for use in a pressure vessel and with a backwash assembly that includes at least one suction nozzle. The filter unit comprises: a filter element support member having at least one support configuration; and at least one filter element supported by the at least one support configuration, the at least one filter element including: at least one first coarse mesh material support layer including apertures of a first size, a first face, and a second face, at least one second coarse mesh material support layer including apertures of a second size, a first face, and a second face, and at least one cloth filter layer including apertures of a third size smaller than the first and second sizes, a first face, and a second face, the at least one cloth filter layer is interposed between the at least one first and second coarse mesh material support layers such that the first face of the at least one first coarse mesh material support layer bears against the second face of the at least one cloth filter layer, and such that the second face of the at least one first coarse mesh material support layer bears against the first face of the at least one cloth filter layer, and a first surface of the filter unit is formed by one of the second face of the at least one first coarse mesh material support layer or the first face of the at least one second coarse mesh material support layer, and unfiltered liquid flows through the filter unit between the first surface of the filter unit and a second surface of the filter unit, and the filter unit has an outlet for flow of filtered liquid to a flow path, and at least one of the first or second surfaces of the filter unit is deployed in facing relation to the at least one suction nozzle.

The term “mesh”, as used in the description and the claims, generally refers to any sheet-like structure having a grid of apertures that constitute at least 50% of its surface area, and preferably at least 18% of its surface area.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is an isometric view of a filter according to an embodiment of the present invention;

FIG. 2 is an isometric view of the filter of FIG. 1, showing part of the outer casing removed;

FIG. 3 is a cut-away isometric view of the filter of FIG. 2;

FIG. 4A is an isometric view of a filter unit, implemented as a filter disk, from the filter of FIG. 2, taken from in front of the filter unit;

FIG. 4B is an isometric view of the filter unit of FIG. 4A, with a first filter element separated from the underlying support structure;

FIG. 4C is an isometric view of the filter unit of FIG. 4A, taken from behind the filter unit showing a second filter element of the filter unit;

FIG. 5 is a cut-away isometric view illustrating a schematic representation of the filter element of FIG. 4B;

FIG. 6 is a sectioned view illustrating a schematic representation of the filter element of FIG. 5, showing the layered structure of the filter element;

FIG. 7 is a sectioned exploded view illustrating the layers of the filter element of FIG. 6;

FIG. 8 is a sectioned view illustrating a schematic representation of a filter element according to another embodiment of the present invention;

FIG. 9 is a sectioned exploded view illustrating the layers of the filter element of FIG. 8;

FIG. 10 is a sectioned view illustrating a schematic representation of a filter element according to yet another embodiment of the present invention;

FIG. 11 is a sectioned exploded view illustrating the layers of the filter element of FIG. 10;

FIG. 12 is an isometric view of a filter unit implemented as a cylindrical filter, according to an embodiment of the present invention;

FIG. 13 is a top view illustrating a schematic representation of the filter unit of FIG. 12; and

FIG. 14 is a top view showing only some of the layers of the filter unit of FIG. 13, with the layers being shown as separated for clarity of illustration.

### DESCRIPTION OF THE PREFERRED EMBODIMENTS

Embodiments of the present disclosure are directed to a filter, having a filter unit that has a cloth filter layer, for filtering a flow of liquid.

The principles and operation of filters according to embodiments of the present disclosure may be better understood with reference to the drawings and the accompanying description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

It should be noted that, throughout this document, the term “water” may be used interchangeably with “liquid” as a typical example, but the embodiments of the present disclosure are not limited to use with water, and may equally be used with brine, other water-based solutions, and in non-water-based applications, such as in the petrochemical industry.

It is further noted herein that the various components of the embodiments of the present disclosure, as illustrated in the drawings, are not necessarily shown to scale, and that in some cases the dimensions of such components are exaggerated for clarity of illustration of the structure of those components.

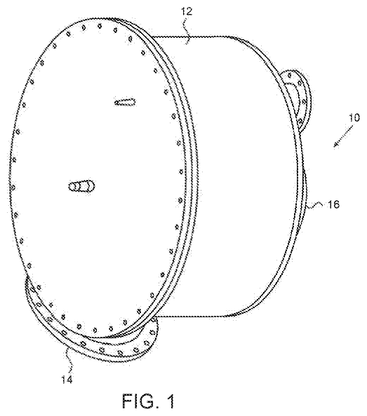

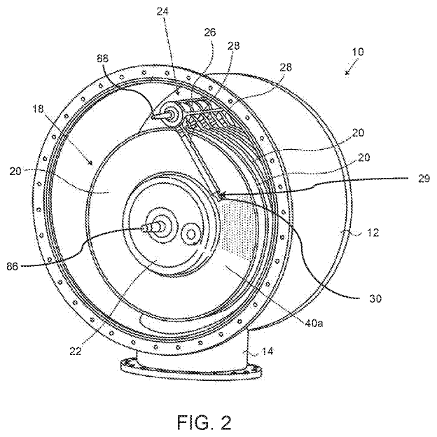

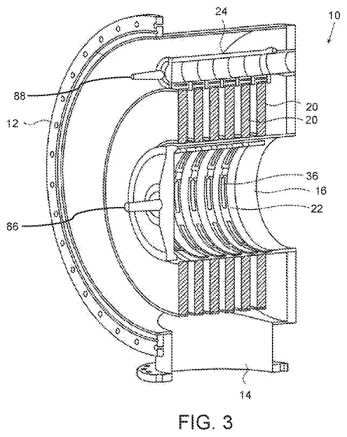

Referring now to the drawings, FIGS. 1-3 illustrate various views of a filter, generally designated 10, constructed and operative according to an embodiment of the present disclosure, for filtering a flow of liquid. Generally speaking, the filter 10 includes a pressure vessel 12 having an inlet 14 and an outlet 16. A filter assembly 18 is deployed within the pressure vessel 12, as best seen in FIGS. 2 and 3. The filter assembly 18 includes at least one filter unit 20 (referred to hereinafter as filter unit 20). The filter unit 20 may be implemented in various ways according to the teachings of the present disclosure. For example, in the non-limiting implementation illustrated in FIGS. 2 and 3, the filter unit 20 is implemented as a plurality of filter disks coaxially arrayed along a central flow path 22 that is in fluid flow communication with the outlet 16. In other implementations, the filter unit 20 is implemented as a cylindrical filter structure, as will be discussed in subsequent sections of this document. Regardless of the specific implementation of the filter unit 20, according to the teachings of the present disclosure, the filter unit 20 includes at least one filter element that is formed as a layered structure that is composed of various support layers and one (or more) non-metal filter layers. As will be discussed, the filter 10 is implemented as a “self-cleaning” filter system, in that the filter 10 includes components that are operative to remove particles which build up and accumulate on the filter unit 20 during filtering of liquid by the filter 10.

As will be discussed in subsequent sections of this document, the filter element according to embodiments of the present disclosure employs non-woven or woven fabric material as the filter layer. The specific types of materials used to implement the filter layer of the filter element are conventionally used in single use applications, such as in disposable filter bags, and a particular aspect of the filter element according to the teachings of the present disclosure is the utilization of such non-woven or woven fabric materials in formation of the filter layer of a filter element used in a “self-cleaning” filter system that is based on a suction-scanning cleaning methodology.

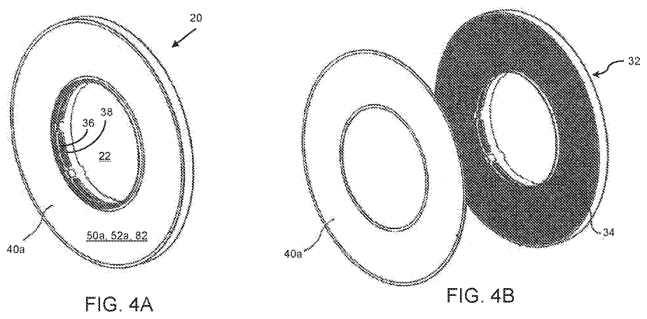

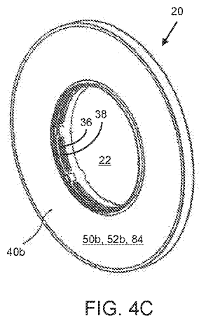

With continued reference to FIGS. 1-3, refer now to FIGS. 4A-7, various views of the filter unit 20, and corresponding components thereof, according to a non-limiting implementation of the filter unit 20 as a plurality of filter disks. A single such filter disk is shown in FIGS. 4A-4C for clarity.

As seen in FIGS. 4A-4C, each filter disk is formed from a generally rigid filter element support member (implemented as a spacer in the present embodiment) 32 that includes first and second outward-facing support configurations 34 for supporting first and second filter elements 40a, 40b overlaying opposite surfaces of the filter unit 20. The filter element support member 32 may be formed with an arrangement of support ribs (not shown) to maintain a desired spacing between the support configurations 34. The support configurations 34 are generally porous in structure, so as to allow the flow of filtered liquid into the space between the support configurations 34. The filter element support member 32 includes one or more sets of one or more outlets 36 for flow of filtered liquid from the space between the support configurations 34 radially inward. The filter element support member 32 further includes one or more flow path openings 38, with each flow path opening 38 corresponding to one of the sets of the outlets 36, for receiving the flow of filtered liquid from the sets of outlets 36 and directing the received flow to the central flow path 22.

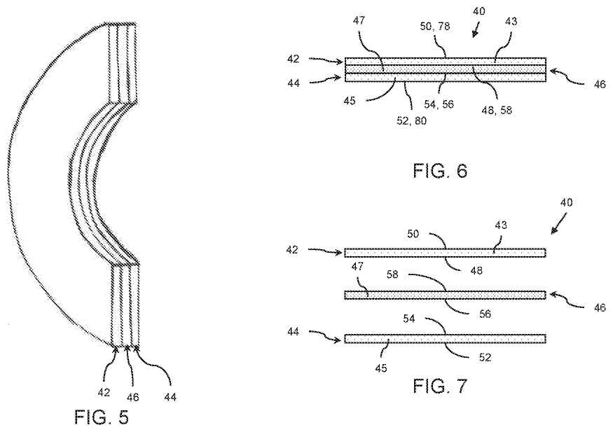

As alluded to above, each of the filter elements 40a, 40b is formed as a multi-layered filter structure that is composed from various layers. Specifically, each of the filter elements 40a, 40b is composed from at least three layers, and in certain embodiments may include up to six (or more) layers. The general structure of a three-layered variations of the filter elements 40a, 40b will now be described for a single filter element, generally designated as 40, with reference to FIGS. 5-7. Throughout this document, when a component of the filter element 40 applies specifically to one of the filter element 40a, 40b, a designator “a” or “b” will be appended to the general designation of that component. In addition, it is noted that the thicknesses of the various layers of the filter element 40 shown in the drawings are exaggerated for clarity of illustration of the composition of the filter element 40.

The outermost layers of the filter element 40 consist of coarse mesh support layers, preferably constructed as metal mesh (i.e., formed from a metal material), shown in the drawings as a first coarse mesh support layer 42 and a second coarse mesh support layer 44. A cloth filter layer 46 is interposed (sandwiched) between the coarse mesh support layers 42, 44. Each of the coarse mesh support layers 42, 44 has corresponding coarse apertures (i.e., openings) 43, 45, of size preferably in the range of 100-300 microns (μm). According to certain embodiments, the aperture sizes of the apertures 43 of the first coarse mesh support layer 42 are the same as the aperture sizes of the apertures 45 of the second coarse mesh support layer 44.

Each of the coarse mesh support layers 42, 44 and the cloth filter layer 46 includes opposing first and second faces. Specifically, as shown in FIGS. 6 and 7, the first coarse mesh support layer 42 includes a first face 48 and a second face 50 (generally opposite the first face 48), the second coarse mesh support layer 44 includes a first face 52 and a second face 54 (generally opposite the first face 52), and the cloth filter layer 46 includes a first face 56 and a second face 58 (generally opposite the first face 56). In a non-limiting configuration, the first coarse mesh support layer 42 is deployed to cover the entirety of the second face 58 of the cloth filter layer 46, and the second coarse mesh support layer 44 is deployed to cover the entirety of the first face 56 of the cloth filter layer 46.

The coarse mesh support layers 42, 44 primarily perform support functionality (as will be discussed) and do not perform major filter functionality. Essentially the entirety of the filter functionality of the filter unit 20 is performed by the cloth filter layer 46.

The cloth filter layer 46 is formed from a fabric of fine mesh having fine apertures (i.e., openings) 47 of size preferably in the range of about 0.5 to 50 μm, and more preferably in the range of about 0.5 to 30 μm. According to certain embodiments, the cloth filter layer 46 is constructed from a non-woven fabric material made from polymer fibers, including, for example, polypropylene or polyester. In certain non-limiting exemplary constructions, the polymer fibers form a polymer felt. Construction of the cloth filter layer 46 from polypropylene or polyester provides an economical filtration solution with predictable filter performance. The Series NB Filter Bags, from 3M™ of Maplewood, Minn., provides an example of non-woven fabric materials (e.g., polypropylene, polyester) which can be used to construct the cloth filter layer 46.

In other embodiments, the cloth filter layer 46 is constructed from a woven fabric material, including woven polymer fibers, including, for example, polypropylene filament yarn filter cloth or polyester filament yarn filter cloth. The various filament yarn filter cloths manufactured by FILMEDIA® of Pudong, China, provide examples of woven fabric materials which can be used to construct the cloth filter layer 46.

It is noted that polymer fibers such as polypropylene or polyester are preferred materials for constructing the cloth filter layer 46 when filtration of very small particulates is desired, where fine apertures 47 in the range of about 5 to 10 μm is required. However, in scenarios in which slightly larger particulate filtering is desired, for example where fine apertures 47 in the range of 25 to 50 μm are sufficient, woven or non-woven nylon fibers may also be used to construct the cloth filter layer 46.

The cloth filter layer 46 is interposed between the coarse mesh support layers 42, 44, as seen in FIG. 6, such that the first face 48 of the first coarse mesh support layer 42 directly bears against (and is at an abutment with) the second face 58 of the cloth filter layer 46, and such that the second face of 54 of the second coarse mesh support layer 44 directly bears against (and is at an abutment with) the first face 56 of the cloth filter layer 46. Accordingly, the second face 50 of the first coarse mesh support layer 42 and the first face 52 of the second coarse mesh support layer 44 respectively form the first and second outermost (major) surfaces 78, 80 of the filter element 40. Furthermore, when going from any of the outermost layers of the filter element 40 to the cloth filter layer 46, the aperture sizes of the apertures of the various layers graduate from coarse (i.e., larger) to fine (i.e., smaller).

FIG. 4A. shows the assembled filter unit 20 taken from the front of the filter unit 20, with the first filter element 40a supported on the first outward-facing support configuration of the filter element support member 32. Accordingly, a first outermost (major) surface 82 of the filter unit 20 is formed by either of the outermost faces 50a, 52a of the first filter element 40a. FIG. 4C shows the assembled filter unit 20 taken from the back of the filter unit 20, with the second filter element 40b supported on the second outward-facing support configuration of the filter element support member 32. Accordingly, a second outermost (major) surface 84 of the filter unit 20 is formed by either of the outermost faces 50b, 52b of the first filter element 40b.

As alluded to in previous sections of this document, preferred implementations of the embodiments of the present disclosure are pressurized systems. These pressurized systems operate at pressures typically in the range of 1-20 atmospheres (where non-pressurized systems are referred to as being at zero pressure), and in many cases more than 6 atmospheres, requiring implementation using a pressure vessel (e.g., the pressure vessel 12). The use of a closed pressurized system allows much higher filter throughput than can be achieved with non-pressurized system, where any pressure differential driving liquid through the filter is inherently limited to a fraction of an atmosphere. In embodiments in which the filter unit 20 is implemented as a plurality of filter disks (as in FIGS. 4A-7), the relatively large filter surface area leads to large compression loads on the cloth filter layer 46, wherein the pressure differential across the filter unit 20 may compromise the structural integrity of the cloth filter layer 46 if proper support structures are not employed. For example, each square centimeter of filter surface area experiences approximately 1 kg force per atmosphere of the system operating pressure, which effects each of the outermost surfaces 82, 84 of the filter unit 20. For a filter with mesh surface area of 1 square meter, corresponding to 5,000 square centimeters on each of the outermost faces of the filter, the filter experiences compressive forces equivalent to a load of 10,000 kg force per atmosphere of pressure differential. Accordingly, the employment of the coarse mesh support layers 42, 44 as the outermost layers of the filter elements 40a, 40b provides a load spreading functionality across the surface area of the filter unit 20, which enables the cloth filter layer 46 of the filter elements 40a, 40b to withstand high pressure differential, in particular when the filter unit 20 undergoes backwash cleaning when implemented as part of a self-cleaning filter. The backwash cleaning of the filter unit 20 will now be discussed.

During operation, the liquid to be filtered (i.e., unfiltered liquid) fills the interior portion of the pressure vessel 12 (which acts as a chamber) such that the filter assembly 18 is fully immersed in the unfiltered liquid. The unfiltered liquid enters the filter unit 20 through both major surfaces 82, 84 of the filter unit 20 and is filtered by the cloth filter layer 46 in each of the filter elements 40a, 40b. As discussed above, the filtered liquid flows radially inward via the sets of outlets 36 to the flow path openings 38 and then to the central flow path 22.

In order to allow continuous (or near continuous) operation of the filter 10, removal of particles, which build up and accumulate on the cloth filter layer 46, during operation of the filter 10, is paramount. In contrast to non-pressurized systems in which spray jets or the like are deployed to clean filter elements, filter element cleaning in a pressurized is performed by backwash of the filtered liquid (i.e., filtrate) in a reverse direction through the filter unit. The following paragraphs describe the general structure of a backwash assembly 24 which provides for filter cleaning functionality.

Referring again to FIGS. 2 and 3, the backwash assembly 24 is formed from a backwash exhaust conduit 26 from which there project a set of backwash arms 28. Each backwash arm 28 terminates in a suction head 29 that includes a suction nozzle 30 in facing relation to one of the major surfaces 82, 84 of the filter unit 20. In principle, when the filter unit 20 is implemented as a plurality of filter disks, the backwash arms 28 extend between neighboring filter disks such that at least one of the major surfaces of each filter disk has a suction nozzle 30 is facing relation therewith. Each backwash arm 28 may include a pivot arrangement (not shown) which allows the suction head 29 to come into close enough contact (i.e., intimate contact) with the filter elements 40a, 40b such that the suction nozzle 30 sucks up the built-up particles. The suction action achieved by the suction head 29 and suction nozzle 30 is passive suction, which is brought about due to the pressure differential across the filter unit 20. Specifically, as the filtered liquid flows out of the filter unit 20 into the central flow path 22, the pressurization of the unfiltered liquid in the pressure vessel 12, together with a reverse flow of some of the filtered liquid back through the flow path openings 38, initiates the suction action.

Parenthetically, the pressure differential across the filter unit 20 is generally the difference in pressure between the regions of the filter unit 20 that are exposed to the unfiltered liquid (at approximately atmospheric pressure), and the regions of the filter unit 20 that are exposed to the filtered liquid. When the filter unit 20 is implemented as a plurality of filter disks coaxially arrayed along a central flow path 22, the regions exposed to atmospheric pressure include the radial outward extreme portions (i.e., radial peripheral portions) of the filter unit 20 (and may also include the outward facing surfaces of the filter disks at the ends of the array). Further, the regions of the filter unit 20 that are exposed to the filtered liquid are the radial inward extreme portions of the filter unit 20 (i.e., the portions of the filter unit 20 that are closest to the central flow path 22).

The backwash assembly 24 is operated by a drive arrangement (not shown), which is configured to simultaneously rotate the filter assembly 18 about its central axis (which extends through, and along the length of, the central flow path 22) and to displace the backwash arms 28 to-and-fro so that each suction nozzle 30 moves through a range of radial positions on the filter unit 20. The combined result of these two motions is that each suction nozzle 30 follows a spiral tracking motion across the corresponding major surface 82, 84 of the filter unit 20 so as to achieve full coverage of the major surfaces 82, 84 of the filter unit 20.

External linkages 86 and 88 may be provided for rotating the filter unit 20 about the central axis, and for displacing the backwash arms 28, respectively. The linkages 86, 88 may be actuated by a drive arrangement (not shown), implemented, for example, as a motor coupled to a transmission unit.

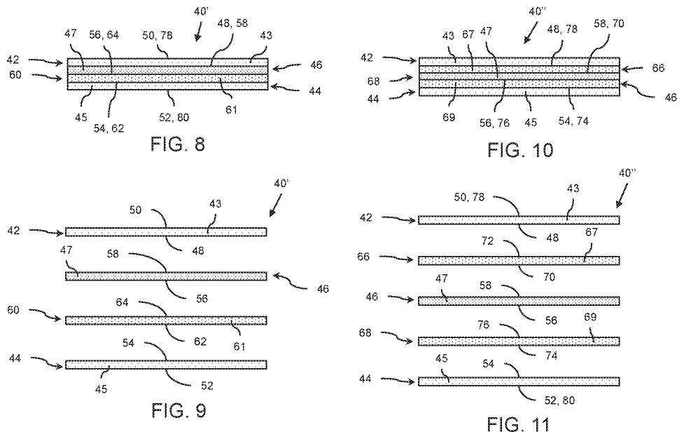

As mentioned above, in certain embodiments, the filter of the present disclosure may include more than three layers. Refer now to FIGS. 8 and 9, a filter unit 40′ according to an embodiment of the present disclosure that includes four layers. Similar to the filter unit 40, the filter unit 40′ includes a cloth filter layer 46 interposed between two coarse mesh layers 42, 44 such that the coarse mesh layers 42, 44 are the outermost layers of the filter unit 40′, and the second face 50 of the first coarse mesh support layer 42 and the first face 52 of the second coarse mesh support layer 44 respectively form the first and second outermost (major) surfaces 78, 80 of the filter element 40′.

However, the filter unit 40′ further includes an additional layer of coarse mesh material deployed directly between the cloth filter layer 46 and one of the coarse mesh layers 42, 44 to act as a spacer to facilitate smooth fluid flow between the various layers of the filter unit 40′. The additional layer, referred to as a coarse mesh spacer layer 60, includes a first face 62 and a second face 64 (opposite the first face 62).

In the embodiments shown in FIGS. 8 and 9, the cloth filter layer 46 is interposed between the coarse mesh support layers 42, 44, such that only one of the faces 48, 54 directly bears against (and is at an abutment with) the corresponding faces 58, 56 of the cloth filter layer 46. In the non-limiting implementation shown in FIGS. 8 and 9, the coarse mesh spacer layer 60 is interposed between the cloth filter layer 46 and the second coarse mesh support layer 44. In this configuration, the first face 48 of the first coarse mesh support layer 42 directly bears against (and is at an abutment with) the second face 58 of the cloth filter layer 46, and such that the second face 64 of the coarse mesh spacer layer 60 directly bears against the first face 56 of the cloth filter layer 46, and such that the second face of 54 of the second coarse mesh support layer 44 directly bears against (and is at an abutment with) the first face 62 of the coarse mesh spacer layer 60 so as to indirectly bear against the first face 56 of the cloth filter layer 46.

The coarse mesh spacer layer 60 may be constructed from various materials, and is preferably constructed from a polymer material, such as, for example polypropylene. The coarse mesh spacer layer 60 has coarse apertures (i.e., openings) 61, which are larger in size than the apertures 47 of the cloth filter layer 46 but smaller in size than the apertures 43, 45 of the coarse mesh support layers 42, 44. Accordingly, just as with the filter unit 40, when going from any of the outermost layers of the filter unit 40′ to the cloth filter layer 46, the aperture sizes of the layers graduate from coarse (i.e., larger) to fine (i.e., smaller).

Although the embodiments of the present disclosure discussed thus far have pertained to filters having two coarse mesh support layers, other embodiments are possible in which the cloth filter layer 46 is supported on both sides by more than two coarse mesh support layers. FIGS. 10 and 11 show a filter unit 40″ in which the cloth filter layer 46 is sandwiched between two sets of two coarse mesh support layers. The filter unit 40″ is generally similar to the filter unit 40 except that the filter unit 40″ further includes a third coarse mesh support layer 66 and a fourth coarse mesh support layer 68. The third coarse mesh support layer 66 includes a first face 70 and a second face 72 (opposite the first face 70), and the fourth coarse mesh support layer 68 includes a first face 74 and a second face 76 (opposite the first face 74). The third coarse mesh support layer 66 is interposed between the first coarse mesh support layer 42 and the cloth filter layer 46, and the fourth coarse mesh support layer 68 is interposed between the second coarse mesh support layer 44 and the cloth filter layer 46. In this configuration, the first face 70 of the third coarse mesh support layer 66 directly bears against (and is at an abutment with) the second face 58 of the cloth filter layer 46, and the second face 76 of the fourth coarse mesh support layer 68 directly bears against (and is at an abutment with) the first face 56 of the cloth filter layer 46.

Each of the coarse mesh support layers 66, 68 has corresponding coarse apertures (i.e., openings) 67, 69, preferably in the range of 100-300 microns (μm). Preferably, but not necessarily, the aperture sizes of the apertures 67 of the third coarse mesh support layer 66 are the same as the aperture sizes of the apertures 69 of the second coarse mesh support layer 68. Further still, the aperture sizes of the apertures 43, 45 of the coarse mesh support layers 42, 44 (i.e., the outermost support layers) are preferably larger (i.e., coarser) than the aperture sizes of the apertures 67, 69 of the coarse mesh support layers 66, 68 (i.e., the outermost support layers). Accordingly, just as with the filter units 40 and 40′, when going from any of the outermost layers of the filter unit 40″ to the cloth filter layer 46, the aperture sizes of the layers graduate from coarse (i.e., larger) to fine (i.e., smaller).

As should be apparent to one of ordinary skill in the art, the features of the filter units 40′ and 40″ may be combined to form a six-layered filter having a cloth filter layer 46, four coarse mesh support layers 42, 44, 66, 68 and a coarse mesh spacer layer 60 deployed directly between the cloth filter layer 46 and one of the coarse mesh layers 42, 44. Furthermore, other embodiments are contemplated in which additional coarse mesh support layers and/or coarse mesh spacer layers are deployed to form a filter having more than six layers.

Although not shown in the drawings, the filter unit 20 may include clamping arrangements or mechanical fastening arrangements deployed about the perimeter (i.e., radial extremity) of the filter unit 20 in order to effectuate binding (i.e., attachment) of the layers of the filter element 40 together, and further to effectuate attachment of the filter elements 40a, 40b to the filter element support member 32 and to keep the filter unit 20 in place during operation of the filter 10. In certain embodiments, each of the filter elements 40a, 40b may have, in addition to a general clamping arrangement or mechanical fastening arrangement of the filter unit 20, its own dedicated clamping arrangement or fastening arrangement for binding the layers of the respective filter elements 40a, 40b.

As mentioned above, the layered filter element may also be used in implementations in which the filter unit is configured as a cylindrical filter structure. The following paragraphs describe embodiments of a such a cylindrical filter unit. It is noted that the layers of the cylindrical filter are generally similar to the layers of the disk-type filter previously described, and should be understood by analogy thereto unless explicitly stated otherwise.

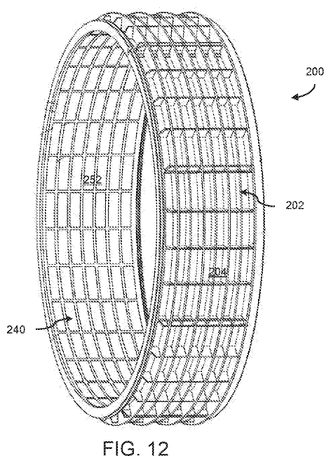

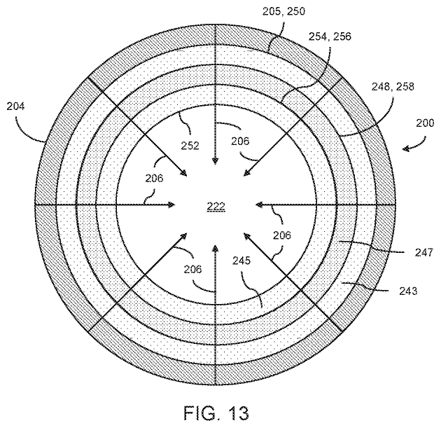

Refer now to FIGS. 12-14, various views of a filter unit 200, constructed and operative according to an embodiment of the present disclosure. As with the filter unit 20, the filter unit 200 can be deployed as part of a filter assembly 18 in a pressure vessel of a filter designated as a self-cleaning filter. A plurality of such filter units 200 can be deployed within the same pressure vessel, with each filter unit 200 having the same general orientation. The filter unit 200 includes a filter element support member 202, in the form of a rigid and porous filter element support member 202 that may be constructed from a rigid plastic material, that forms a skeleton-type structure that supports a filter element 240. FIG. 13 illustrates a top view of the assembled filter unit 200, in which the filter element support member 202 is shown as the outermost ring of the filter unit 200. The filter element 240 is integrated to the filter element support member 202 through an attachment mechanism, for example, a clamping arrangement or the like.

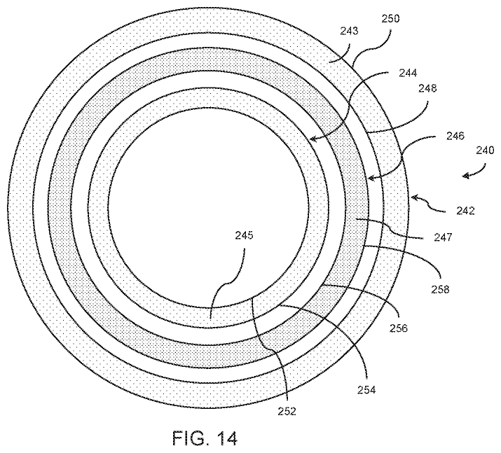

FIG. 14 shows the separate layers of the filter element 240 (similar to as shown in FIGS. 7, 9 and 11), with the thicknesses of the various layers being exaggerated for clarity of illustration. The filter element 240 includes a cloth filter layer 246 sandwiched between two coarse mesh support layers 242, 244. In the non-limiting exemplary configuration shown in FIGS. 13 and 14, the first coarse mesh support layer 242 is the outermost layer of the filter element 240, and the second coarse mesh support layer is the innermost layer of the filter element 240.

The first coarse mesh support layer 242 has first and second faces 248, 250. The second coarse mesh support layer 244 has first and second faces 252, 254. The cloth filter layer 246 has first and second faces 256, 258. In configuration shown in FIGS. 12-14, when assembled, the first face 248 of the first coarse mesh support layer 242 directly bears against (and is at an abutment with) the second face 258 of the cloth filter layer 246, and the second face 254 of the second coarse mesh support layer 244 directly bears against (and is at an abutment with) the first face 256 of the cloth filter layer 246. As should be apparent, additional configurations are contemplated in which the filter element 240 includes more than three layers, for example, configurations in which a spacer layer is deployed between the cloth filter layer 246 and one of the coarse mesh support layers 242, 244, and configurations in which the cloth filter layer 246 is sandwiched between two sets of two coarse mesh support layers.

In the non-limiting exemplary configuration shown in FIGS. 12-14, the first face 252 of the second coarse mesh support layer 244 forms the first major (interior) surface of the filter unit 200. The exterior face 204 of the filter element support member 202 forms the second major (exterior) surface of the filter unit 200. The filter element 240 is integrated to the filter element support member 202 via attachment of the second face 250 of the first coarse mesh support layer 242 to the interior face 205 of the filter element support member 202, which acts a support configuration that supports the filter element 240.

As mentioned above, the filter unit 200 can be deployed in a pressure vessel (similar to the pressure vessel 12) as part of a filter that includes a self-cleaning mechanism (e.g., backwash assembly). In such configurations, the filter unit 200 is deployed between the inlet and outlet of the pressure vessel, such that a fluid flow path 206 between the inlet and outlet necessarily passes through the cloth filter layer 246 of the filter unit 200. Unlike the embodiments described with reference to FIGS. 2-4C in which the filter 20 is arrayed along the central flow path 22, the filter unit 200 of the present embodiments is deployed in the pressure vessel such that a fluid flow path 206 extends radially through the filter element 240, and more particularly is oriented radially inward toward the center of the filter unit 200. The aperture openings of the second coarse mesh support layer 244 provide flow outlets to allow the flow of the filtered liquid, flowing along the flow path 206, to flow a central flow path 222 that extends along the length of the filter unit 200 (normal to the plane of the page in FIG. 13).

The filter unit 200 can be deployed in the pressure vessel in combination with a backwash assembly, similar to the backwash assembly 24 with several modifications. For example, the backwash assembly 24 can be deployed on the exterior surface of the filter unit 200, such that the suction nozzle 30 is in facing relation to the exterior surface 204 of the filter unit 200 and is brought into intimate contact with the exterior surface such that the pressure differential, effectuated by the pressurization of the unfiltered liquid on the outside of the filter unit 200, and the filtered liquid moving along the central flow path 222 along the interior cylindrical section of the filter unit 200, sucks up the particles that are built-up on the second face 258 (outermost face) of the cloth filter layer 246.

A drive arrangement can be provided to simultaneously rotate the filter unit 200 about its longitudinal axis and to displace the backwash arms 28 to-and-fro so that each suction nozzle 30 moves through a range of longitudinal positions on the exterior surface 204 of the filter unit 200. The combined result of these two motions is that each suction nozzle 30 follows an oscillating, somewhat elliptical or sinusoidal, tracking motion across the exterior surface 204 of the filter unit 200 so as to achieve full coverage of the exterior surface 204 of the filter unit 200. Note that multiple backwash arms may be deployed such that each suction nozzle 30 is in facing relation to a different portion or region of the exterior surface 204 of the filter unit 200.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A filter for filtering a flow of liquid, comprising:
a pressure vessel having an inlet, an outlet, and a flow path in fluid communication with the outlet;
a filter assembly deployed within the pressure vessel, the filter assembly including at least one filter unit including at least one filter element and a filter element support member having at least one support configuration that supports the at least one filter element, wherein the at least one filter element includes:
at least one first coarse mesh material support layer having two faces and including apertures of a first size,
at least one second coarse mesh material support layer having two faces and including apertures of a second size, and
at least one cloth filter layer having two faces and including apertures of a third size smaller than the first and second sizes, wherein the at least one cloth filter layer is interposed between the at least one first and second coarse mesh material support layers such that one of the faces of the at least one first coarse mesh material support layer bears against one of the two faces of the at least one cloth filter layer, and such that one of the faces of the at least one second coarse mesh material support layer bears against an other one of the two faces of the at least one cloth filter layer, and wherein unfiltered liquid flows through the at least one filter unit between a first surface of the at least one filter unit, formed by one of faces of the first or second coarse mesh material support layer, and a second surface of the at least one filter unit, formed by one of faces of the second or first coarse mesh material support layer, and wherein the at least one filter unit has an outlet for flow of filtered liquid to the flow path; and
a backwash assembly including at least one suction nozzle deployed in facing relation to at least one of the first or second surfaces of the at least one filter unit.

2. The filter of claim 1, wherein the third size is in a range between 0.5 microns and 30 microns.

3. The filter of claim 1, wherein the first and second sizes are in a range between 50 microns and 600 microns.

4. The filter of claim 1, wherein the at least one first coarse mesh material support layer is deployed to cover substantially the entirety of the one of the two faces of the at least one cloth filter layer, and wherein the at least one second coarse mesh material support layer is deployed to cover substantially the entirety of the other one of the two faces of the at least one cloth filter layer.

5. The filter of claim 1, wherein the at least one first coarse mesh material support layer includes a first plurality of coarse mesh material support layers, and wherein the at least one second coarse mesh material support layer includes a second plurality of coarse mesh material support layers.

6. The filter of claim 5, wherein the first plurality of coarse mesh material support layers includes an innermost coarse mesh material support layer and an outermost coarse mesh material support layer, and wherein the innermost coarse mesh material support layer is a closest layer of the first plurality of coarse mesh material support layers to the one of the two faces of the at least one cloth filter layer, and wherein the outermost coarse mesh material support layer is a farthest layer of the first plurality of coarse mesh material support layers from the one of the two faces of the at least one cloth filter layer, and wherein the second plurality of coarse mesh material support layers includes an innermost coarse mesh material support layer and an outermost coarse mesh material support layer, and wherein the innermost coarse mesh material support layer of the second plurality of coarse mesh material support layers is a closest layer of the second plurality of coarse mesh material support layers to the other one of the two faces of the at least one cloth filter layer, and wherein the outermost coarse mesh material support layer of the second plurality of coarse mesh material support layers is a farthest layer of the second plurality of coarse mesh material support layers from the other one of the two faces of the at least one cloth filter layer.

7. The filter of claim 5, wherein each coarse mesh material support layer of the first and second pluralities of coarse mesh material support layers has apertures of a size larger than the third size.

8. The filter of claim 1, wherein the at least one first coarse mesh material support layer includes exactly one coarse mesh material support layer, and wherein the at least one second coarse mesh material support layer includes exactly one coarse mesh material support layer.

9. The filter of claim 1, further comprising:
at least one coarse mesh material spacer layer interposed between the at least one cloth filter layer and one of the coarse mesh material support layers.

10. The filter of claim 1, wherein the at least one first and second coarse mesh material support layers are formed from metal mesh.

11. The filter of claim 1, wherein the at least one cloth filter layer is formed from a non-woven fabric.

12. The filter of claim 11, wherein the non-woven fabric is made from polymer fibers.

13. The filter of claim 12, wherein the polymer fibers include polypropylene or polyester.

14. The filter of claim 1, wherein the at least one cloth filter layer is formed from a woven fabric.

15. The filter of claim 1, wherein the at least one filter unit forms a disk filter structure.

16. The filter of claim 1, wherein the at least one filter unit forms a cylindrical filter structure.

17. The filter of claim 1, wherein the first and second sizes are equal.

18. A filter unit for filtering a flow of liquid, the filter unit for use in a pressure vessel and with a backwash assembly that includes at least one suction nozzle, the filter unit comprising:
a filter element support member having at least one support configuration; and
at least one filter element supported by the at least one support configuration, the at least one filter element including:
at least one first coarse mesh material support layer including apertures of a first size, a first face, and a second face,
at least one second coarse mesh material support layer including apertures of a second size, a first face, and a second face, and
at least one cloth filter layer including apertures of a third size smaller than the first and second sizes, a first face, and a second face, wherein the at least one cloth filter layer is interposed between the at least one first and second coarse mesh material support layers such that the first face of the at least one first coarse mesh material support layer bears against the second face of the at least one cloth filter layer, and such that the second face of the at least one first coarse mesh material support layer bears against the first face of the at least one cloth filter layer, and wherein a first surface of the filter unit is formed by one of the second face of the at least one first coarse mesh material support layer or the first face of the at least one second coarse mesh material support layer, and wherein unfiltered liquid flows through the filter unit between the first surface of the filter unit and a second surface of the filter unit, and wherein the filter unit has an outlet for flow of filtered liquid to a flow path, and wherein at least one of the first or second surfaces of the filter unit is deployed in facing relation to the at least one suction nozzle.
